(19) United States
(12) Patent Application Publication
(10) Pub. No.: US 2008/0199134 A1
(43) Pub. Date: Aug. 21, 2008

(54) System for identifying optical fibers and cables

(75) Inventor: Thomas C. Cook, Woodstock, GA (US)

Correspondence Address: KING & SPALDING LLP, 1180 PEACHTREE STREET, ATLANTA, GA, 30309-3521, US

(73) Assignee: Superior Essex Communications LP, Atlanta, GA (US)

(21) Appl. No.: 11/706,541

(22) Filed: Feb. 15, 2007

(51) Int. Cl. G02B 6/02

(52) U.S. Cl. 385/123

(57) ABSTRACT

An optical fiber or a cable can comprise marks that uniquely identify the fiber or cable and that facilitate tracing materials thereof back to manufacturing. The marks can extend lengthwise along the fiber or cable, for example from end-to-end. A user of the optical fiber or cable can make an identification from an end-on view. The marks can be encoded with information based on the number of marks, the widths of the individual marks, and/or the spacing between each mark. The marks can comprise a continuous barcode that is integrated into a material of the optical fiber or cable. The glassy material of a fiber optic preform can comprise an embedded set of enlarged marks, so that drawing optical fiber from the preform pulls marks of appropriate size into the fiber's cladding material. The marks can alternatively comprise encoded stripes extruded into a cable jacket.

### FIELD OF THE INVENTION

The present invention relates to communication cables with electrical, twisted pair, fiber optical, or other conductors and any combination thereof. More specifically, the present invention relates to marks extending lengthwise along a fiber or cable allowing a user of the optical fiber or cable to identify information about the cable or fiber from an end-on view of the cut face of the cable or fiber.

### BACKGROUND

As the desire for enhanced communication escalates, electrical and fiber optical data transmission cables are deployed in ever denser numbers within conduits, cable trays, wiring closets, crawl spaces, ceilings, buried underground and strung from poles. Traditionally, identifying one cable from another or ascertaining information about a cable required the user to obtain an outside view of the jacket of a cable to attempt to read the manufacturer's markings on the cables. Such traditional markings are usually printed intermittently on the outside of a cable jacket.

Intermittent jacket printing is spaced out along the outside jacket of the cable with spacing of several inches, a foot, or more between markings. A user working on a cable deployed into a tight or densely packed cable tray, conduit, or other space may only have visual access to a small length of the cable. In a difficult scenario, a user making a repair splice or other field operation on a cable with little or no cable slack may only have visual access to the end-on cross-section of the cable. In field situations such as these, the intermittent markings on the outside of the cable jacket are often of little or no use to the user. Extraction of enough of a cable to obtain visual access to its outer jacket can require more invasive operations to be made on the cable or those cables around it.

Printing on the outside jackets of cables is often very small due to limited space on the jacket. Additionally, the printing may become damaged or scratch off completely during installation, wear, or from exposure to light, water, vapors, or chemicals. These difficulties in accessing identifying information on a cable add time, expense, and complication to field operations on deployed communication cables.

Accordingly, there is a need in the art for efficiently marking electrical or fiber optical communication cables so that the cable information can be read from a cross-sectional cut face of the cable instead of intermittently at some point along the outside of the cable jacket.

### SUMMARY

The present invention supports an optical fiber or a cable with marks that extend lengthwise along the fiber or cable. Within an optical fiber, the marks can run lengthwise or longitudinally through the cladding of the fiber. Within any cable, including those with optical fibers, electrical conductors, or both, for example, the jackets or insulators can be extruded with stripes that mark the cable all along its length. In either the cable jacket or the fiber cladding example, the markings can be formed so that an end-on view of the cut face at any point along the fiber or cable provides visual access to the markings. From such an end-on view of the markings, information about the fiber or cable can be ascertained.

The marks can be encoded with information based on the number of marks, the size of the individual marks, and/or the spacing between each mark. A user of the optical fiber or cable can view the identification markings from end-on at the cut face of the cable or fiber thereby obtaining information about the cable or optical fiber without the need to expose an arbitrary length of the cable to gain visual access to printing on the outside of the jacket.

The discussion of cable and optical fiber identification presented in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, processes, and objects of the present invention will become apparent to one with skill in the art upon examination of the following drawings and detailed description. It is intended that all such aspects, systems, methods, features, advantages, processes, and objects are to be included within this description, are to be within the scope of the present invention, and are to be protected by the accompanying claims.

### BRIEF DESCRIPTION OF THE DRAWINGS

FIG. 1 illustrates an end-on view of an optical fiber with markings in the fiber cladding according to one exemplary embodiment of the present invention.

FIG. 2 illustrates a side view of an optical fiber with markings in the fiber cladding according to one exemplary embodiment of the present invention.

FIG. 3 illustrates an end-on view of a cable jacket with identification markings visible along the entire length of the cable according to one exemplary embodiment of the present invention.

FIG. 4 shows a logical flow diagram representing a process for identifying a cable end-on from a cut face of the cable according to one exemplary embodiment of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimension may be exaggerated to help visually convey such principles. In the drawings, reference numerals designate like or corresponding, but not necessarily identical, elements throughout the several views.

### DETAILED DESCRIPTION OF EXEMPLARY EMBODIMENTS

The present invention supports an optical fiber or a cable with marks that extend lengthwise along the fiber or cable, for example from end-to-end. A user of the optical fiber or cable can observe the identification markings from an end-on view of the cut face of the cable or fiber. The marks can be encoded with information based on the number of marks, the size of the individual marks, and/or the spacing between each mark. The marks can comprise a continuous barcode that is integrated into a material of the optical fiber or cable.

Optical fiber can be made by first constructing a large-diameter preform, with a carefully controlled refractive index profile, and then pulling the preform to form the long, thin optical fiber. The preform can be made by a chemical vapor deposition method and then placed in a drawing tower where the preform tip is heated and the optical fiber is pulled out as a string. The fiber optic preform can have pre-markings embedded within it, so that drawing optical fiber from the preform pulls marks of appropriate size into the fiber's cladding material. Such markings can be viewed end-on or from the side of the fiber over its entire length or a substantial portion of its length. Reading the markings can be considered similar to reading a bar code.

Alternatively, a cable jacket can include stripes extruded into a cable jacket so that the stripes encode information about the cable. Such stripes can be viewed end-on or from the side of the cable over its entire length or a substantial portion of its length. A striping extruder can be used when the jacket is extruded around the cable's internal conductors. The striping extruder allows stripes within the jacket to be extruded from a different material or colored material to form visual stripes within the final jacket extrusion.

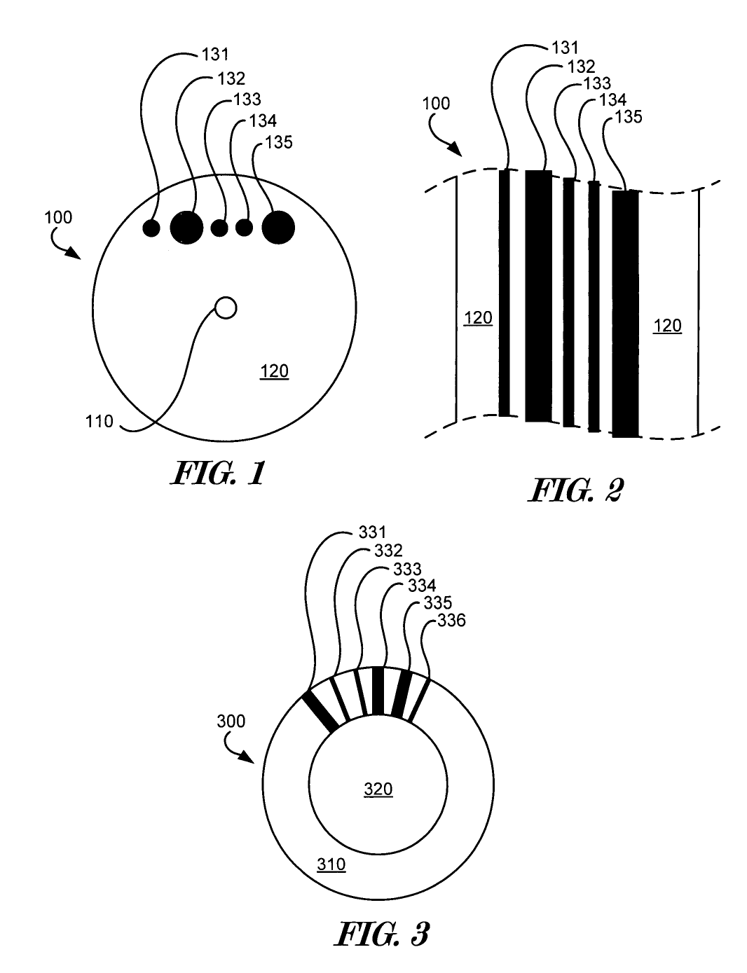

A system and method for identifying cables and optical fibers comprising longitudinal markings will now be described more fully hereinafter with reference to FIGS. 1-4, which describe representative embodiments of the present invention. The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting, and among others supported by representations of the present invention.

Turning now to the drawings, in which like reference numerals refer to like (but not necessarily identical) elements, FIG. 1 illustrates an end-on view of an optical fiber with markings in the fiber cladding according to one exemplary embodiment of the present invention. The optical fiber 100 can have an optical core 110 within a cladding 120. The core 110 can act as a dielectric waveguide wherein optical energy is propagated down the core 110 by total internal reflection. The optical fiber 100 can be designed for single-mode propagation which may involve a core diameter of 8 to 10 microns, or multi-mode operation which may involve a core diameter up to hundreds of microns. The cladding 120 of the optical fiber 100 may be over one hundred to several hundred microns in diameter. The optical fiber 100 can be manufactured of any one of, or a combination of various glasses such as silica, fluorozirconate, fluoroaluminate, or chalcogenide. The optical fiber 100 can also be manufactured of a plastic, crystalline material, or any other material capable of conducting an optical signal.

Markings 131-135 within the cladding 120 of the optical fiber 100 can run longitudinally the entire length of the fiber 100. Information can be encoded into the markings using any number of coding techniques. One exemplary encoding illustrated by FIG. 1 involves the smaller markings 131, 133, 134 representing binary zeros and the larger markings 132, 135 representing binary ones, such that the binary string represented by the markings 131-135 respectively is “01001”. Other examples of encoding may involve multi-level representations where there are more than two sizes of markings or symbols allowing for a 3-ary or n-ary encoding as opposed to the previous example which was a binary or 2-ary encoding scheme. Likewise, the position of the markings 131-135 as arranged spatially within the cladding may encode information. The type of information represented by these codes may include a unique identifier for that specific fiber, information about the manufacturer, the date of manufacture, the type of fiber, the lot number of the fiber, the serial number, physical characteristics of the fiber, or any other information that is desired to be associated with the optical fiber 100.

The longitudinal markings 131-135 can be visually accessed by viewing the cut or cleaved optical fiber 100 end-on. Viewing the markings end-on can be much more accessible during a splice repair or many situations where the fiber is constrained in a small space, conduit, or bundle. Additionally, the markings can also be accessed from the side of the fiber looking through the cladding.

The optical fiber 100 may be manufactured by first constructing a large-diameter preform with the markings 131-135 placed within the cladding region of the preform (not illustrated) by coloring, marking or doping the soot of the preform that will become the markings 131-135. The preform can then be pulled to form the long, thin optical fiber 100 and the markings 131-135 pulled along through the length of the optical fiber 100. The preform may be made by any chemical vapor deposition method such as inside vapor deposition, outside vapor deposition, or vapor axial deposition.

Turning now to FIG. 2, the figure illustrates a side view of an optical fiber with markings in the fiber cladding 120 according to one exemplary embodiment of the present invention. The optical fiber 100 can have an optical core 110 (not illustrated in FIG. 2) within a cladding 120. The optical fiber 100 can be manufactured of any one of, or a combination of various glasses such as silica, fluorozirconate, fluoroaluminate, or chalcogenide.

Markings 131-135 within the cladding 120 of the optical fiber 100 can run longitudinally the entire length of the fiber 100. Information can be encoded into the markings 131-135 using any number of coding techniques. One exemplary encoding illustrated by FIG. 2 involves the smaller markings 131, 133, 134 representing binary zeros and the larger markings 132, 135 representing binary ones, such that the binary string represented by the markings 131-135 respectively is “01001”. Other examples of encoding are detailed with relation to FIG. 1 and are intended to be non-limiting examples.

The type of information encoded within the markings 131-135 may include a unique identified for that specific fiber 100, information about the manufacturer, the date of manufacture, the type of fiber 100, the lot number of the fiber 100, the serial number, physical characteristics of the fiber 100, or any other information that desired to be associated with the optical fiber 100.

The longitudinal markings 131-135 can be visually accessed by viewing the cut or cleaved optical fiber 100 end-on as discussed with respect to FIG. 1. As illustrated in FIG. 2, the markings 131-135 may also be viewed from the side of the optical fiber 100 if the buffer and jacket are removed from the optical fiber 100 so that the cladding 120 is visible.

Turning now to FIG. 3, the figure illustrates an end-on view of a cable jacket with identification markings visible along the entire length of the cable according to one exemplary embodiment of the present invention. An outside jacket 310 of cable 300 is positioned around the interior 320 of cable 300. The interior 320 of cable 300 can include a single electrical conductor, a single optical fiber, multiple insulated electrical conductors, multiple optical fibers, one or more twisted pairs of insulated conductors, RF shielding braid, shielding foil, shielding wire, other shielding, rip cord, insulated filler, foamed filler, paper filler, cross filler, one or more coaxial conductors, one or more transmission lines, one or more waveguides, other signal conductors, structured cable, or any combination thereof. The outside jacket 310 of cable 300 may also be a jacket or insulator inside of another jacket (such as in structured cable) or inside a bundle or conduit. The inventive marking technology may be used at any level of a cable system, such as within insulators or jackets on individual conductors or optical fibers that are part of a larger cable, within jackets around subsets of conductors or fibers within a cable, and/or within the outer-most jacket of the cable system. The inventive marking technology can be used at any, all, or any subset of these (or other) levels within a complex cable system.

The outside jacket 310 of cable 300 can include longitudinal markings 331-336 along the length of the cable 300. Information can be encoded into the markings 331-336 using any number of coding techniques. One exemplary encoding illustrated by FIG. 3 involves the thinner markings 332, 333, 336 representing binary zero and the thicker markings 331, 334, 335 representing binary ones, such that the binary string represented by the markings 331-336 respectively is “100110”. Other examples of encoding are multilevel size coding (more than just two marker thicknesses), position coding, color coding, pattern coding, and various other examples, none of which are intended to be limiting.

The type of information encoded within the markings 331-336 may include a unique identified for the specific cable 300, information about the manufacturer, the date of manufacture, the type of cable 300, the lot number of the cable 300, the serial number, physical characteristics of the cable 300, or any other information that is desired to be associated with the cable 300.

The longitudinal markings 331-336 can be visually accessed by viewing the cut cable 300 end-on. Also, the markings 331-336 may be visually accessed from a side view of the cable 300. The outside jacket 310 of cable 300 can be extruded around the signal conductors positioned inside the cable 320. During extrusion of the outside jacket 310 of the cable 300, the markings 331-336 can be added as colored polymers in the jacket or as part of a striped extrusion process.

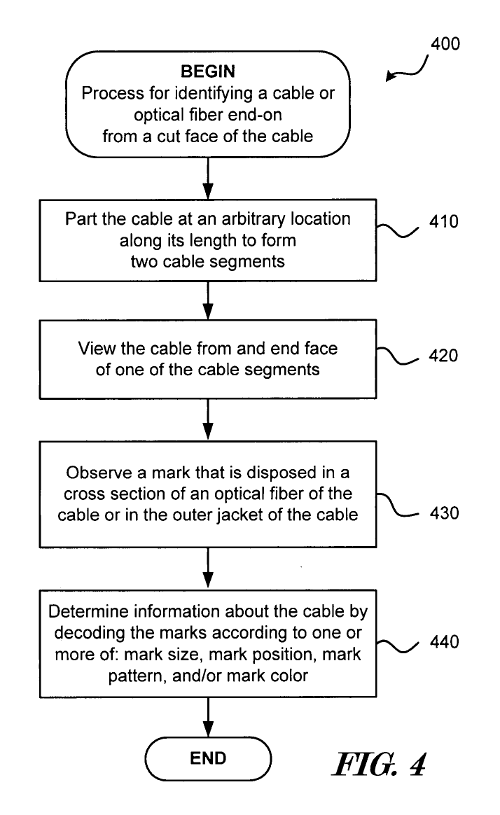

Turning now to FIG. 4, the figure shows a logical flow diagram 400 representing a process for identifying a cable end-on from a cut face of the cable 100, 300 according to one exemplary embodiment of the present invention. Certain steps in the processes or process flow described in all of the logic flow diagrams referred to below must naturally precede others for the invention to function as described. However, the invention is not limited to the order of the steps described if such order or sequence does not alter the functionality of the invention. That is, it is recognized that some steps may be performed before, after, or in parallel with other steps without departing from the scope or spirit of the invention.

In Step 410, the cable may be parted at an arbitrary location along its length to form two cable segments. Parting the cable in this way cuts across the markings 131-135, 331-336 disposed within the cable 100, 300. The “arbitrary” location referred to in Step 410 is intended to imply that the cable can be parted at essentially any location along its length. Use of the term “arbitrary” is not meant to imply that the location is not known, knowable, or able to be specified. Next, in Step 420, the cable 100, 300 may be viewed from the end face of one of the cable segments.

In Step 430, marks can be observed. The marks 131-135, 331-336 may be disposed in a cross section of an optical fiber 100 of the cable or in the outer jacket 310 of the cable 300. As discussed in relationship to FIG. 3, the markings 131-135, 331-336 can be located in any insulator 310, fiber 100, inner jacket 310, or outer jacket 310 of the cable 100, 300, cables assembly, or structured cable. As discussed in relationship to FIGS. 1 and 2, the markings 131-135 in optical fibers 100 may be disposed within the cladding 120 of the optical fiber 100. The marks may also be observed from the side of the optical fiber 100 or the cable 300.

In Step 440, information about the cable is determined by decoding the marks. The marks 131-135, 331-336 can have information encoded by any of mark size, mark position, mark pattern, mark color, or combination thereof, for example. This information can be coded similarly to a bar code, for example. Process 400 ends after Step 440.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is to be limited only by the claims that follow.

1. An optical fiber comprising:
a core having a first index of refraction;
a cladding, adjacent to the core, having an index of refraction different than the first index of refraction; and
one or more marks disposed longitudinally within the cladding and accessible at essentially every cross-section of the optical fiber, wherein the marks encode information about the optical fiber.

2. The optical fiber of claim 1, wherein the marks encode information in a binary format whereby respective cross-sectional geometries of the markings are selected from a set of two substantially different cross-sectional geometries.

3. The optical fiber of claim 1, wherein the marks encode information in an n-ary format whereby respective cross-sectional geometries of the markings are selected from a set of n substantially different cross-sectional geometries.

4. The optical fiber of claim 1, wherein the positions of the marks encode information in an n-ary format whereby respective positions of the markings within the cross-section of the optical fiber are selected from a set of n substantially different cross-sectional positions.

5. The optical fiber of claim 1, wherein the marks are formed by altering material composition of portions of the cladding, wherein the optical fiber has a length, and wherein the one or more marks span the length.

6. The optical fiber of claim 1, wherein the information related to the optical fiber indicates a manufacturer of the optical fiber.

7. The optical fiber of claim 1, wherein the information related to the optical fiber indicates a date of manufacture of the optical fiber.

8. The optical fiber of claim 1, wherein the information related to the optical fiber indicates a manufacturing lot number of the optical fiber.

9. The optical fiber of claim 1, wherein the information related to the optical fiber indicates a unique identification code of the optical fiber.

10. The optical fiber of claim 1, wherein the information related to the optical fiber indicates the a type classification of the optical fiber.

11. A cable comprising:
one or more signal conductors;
an outer jacket disposed around the one or more signal conductors; and
one or more markings disposed longitudinally within the outer jacket as to be accessible at essentially every cross-section of the cable,
each marking having a cross-sectional geometry,
each marking having a position within a cross-section of the outer jacket,
the relative cross-sectional geometries and positions of the markings encoding information related to the cable.

12. The cable of claim 11, wherein each signal conductor is one of an electrical conductor and a fiber optical conductor.

13. The cable of claim 11, wherein the cross-sectional geometries of the markings encode information in a binary format whereby respective cross-sectional geometries of the markings are selected from a set of two substantially different cross-sectional geometries.

14. The cable of claim 11, wherein the positions of the markings encode information in an n-ary format whereby respective positions of the markings within the cross-section of the outer jacket are selected from a set of n substantially different cross-sectional positions.

15. The cable of claim 11, wherein the markings are formed by altering material composition of portions of the outer jacket.

16. The cable of claim 11, wherein the information related to the cable indicates a manufacturer of the cable.

17. The cable of claim 11, wherein the information related to the cable indicates a date of manufacture of the cable.

18. The cable of claim 11, wherein the information related to the cable indicates a manufacturing lot number of the cable.

19. The cable of claim 11, wherein the information related to the cable indicates a unique identification code of the cable.

20. The cable of claim 11, wherein the information related to the cable indicates the a type classification of the cable.

21-27. (canceled)

28. A communication cable having a length and comprising a barcode, the barcode comprising a plurality of marks that span the length.

29. The optical fiber of claim 1, wherein the one or more marks comprises a barcode encoded with the information.

30. The optical fiber of claim 1, wherein the cladding comprises an outer surface opposite the core, and wherein the one or more marks are disposed beneath the outer surface.

31. The optical fiber of claim 1, wherein the cladding comprises a surface circumscribing the cladding, and wherein the one or more marks are disposed under the surface.

32. The optical fiber of claim 1, wherein a first portion of the cladding is disposed between the one or more marks and the core, and wherein the one or more marks is disposed between the first portion of the cladding and another portion of the cladding.

33. The optical fiber of claim 1, wherein the cladding laterally covers the one or more marks.

34. The optical fiber of claim 1, wherein the cladding comprises glassy material.

35. The optical fiber of claim 1, wherein the cladding comprises silica.

36. The optical fiber of claim 1, wherein the cladding adjoins the core at a total internal reflection interface.

37. The optical fiber of claim 1, wherein the one or more marks is visibly accessible from a side of the optical fiber via looking through the cladding.

38. An optical fiber comprising:
a core extending lengthwise along the optical fiber, for propagating optical energy along the optical fiber;
a cladding circumscribing the core and providing an internally reflective interface with the core; and
a plurality of marks, embedded in the cladding and extending lengthwise along the optical fiber, encoded with information about the optical fiber.

39. The optical fiber of claim 38, wherein each of the plurality of marks is fully embedded in the cladding.

40. The optical fiber of claim 38, wherein the cladding comprises glassy material.

41. The optical fiber of claim 38, wherein the plurality of marks comprises a barcode.
